(19) United States
(12) Patent Application Publication
(10) Pub. No.: US 2022/0250189 A1
(43) Pub. Date: Aug. 11, 2022

(54) JOINING COMPONENT MANUFACTURING APPARATUS

(71) Applicant: HONDA MOTOR CO., LTD., Minato-ku, Tokyo (JP)

(72) Inventors: Yasuhiro Ito, Haga-gun, Tochigi-ken (JP); Naoki Takahashi, Haga-gun, Tochigi-ken (JP); Jun Kitagawa, Haga-gun, Tochigi-ken (JP); Akihiro Nemoto, Minato-ku, Tokyo (JP)

(21) Appl. No.: 17/625,790

(22) PCT Filed: Jun. 10, 2020
(86) PCT No.: PCT/JP2020/022814

§ 371 Date: Jan. 10, 2022

(30) Foreign Application Priority Data
Jul. 12, 2019 (JP) 2019-130104

(51) Int. Cl. B23K 26/21; B23K 26/082

(52) U.S. Cl. CPC B23K 26/21; B23K 2103/04; B23K 26/082

(57) ABSTRACT

This joining apparatus, which is a joining component manufacturing apparatus, comprises a pressing-force-applying means that applies a pressing force for pressing a second joining part that is formed on a second workpiece toward a first joining part that is formed on a first workpiece. The joining apparatus is provided with a laser light irradiation device that irradiates a site where the first joining part and the second joining part are brought close together with laser light. The pressing-force-applying means and the laser light irradiation device move as an integrated unit along the direction of extension of the first joining part and the second joining part due to a movement device.

### TECHNICAL FIELD

The present invention relates to a joined product (joining component) manufacturing apparatus for obtaining a joined product by joining a first joining portion of a first workpiece and a second joining portion of a second workpiece.

### BACKGROUND ART

Laser welding is widely known as one technique for joining a plurality of metal workpieces to each other. For example, JP 2004-209549 A describes technology for, while pressing together joining portions layered on top of each other with a pair of pressure rollers, irradiating the joining portions with laser light from the top joining portion (in particular, FIG. 11).

With the laser joining described in JP 2004-209549 A, it is necessary to irradiate the joining portions with the laser light until the top joining portion melts, and therefore there is a large amount of energy consumption. Furthermore, in a case where a workpiece including the joining portions is made of a galvanized steel sheet, blow holes can be formed due to the evaporation of the zinc plating. When such a phenomenon occurs, the resulting joined product is aesthetically unpleasant.

On the other hand, in JP 2018-075596 A, the present applicant proposes a joining method that includes arranging two workpieces made of galvanized steel plates in parallel and irradiating end surfaces thereof facing each other with laser light, and then fusing the melted opposing end surfaces to each other while sandwiching the two workpieces with pressure rollers (in particular, see FIG. 2).

### SUMMARY OF THE INVENTION

In a case where a workpiece is manufactured using press forming, there is a tendency for springback to occur in the workpiece. Therefore, in a case where a joining portion is flange portions layered on each other, for example, the flange portions warp staring from a starting end portion, and as a result, it is possible for the flange portions to separate significantly from each other. With the techniques disclosed in JP 2004-209549 A and JP 2018-075596 A, it is not easy to join such flanges together.

The present invention has the object of providing a joined product manufacturing apparatus with which the joined product can be easily obtained even when the regions being joined together separate from each other.

According to an aspect of the present invention, there is provided a joined product manufacturing apparatus for obtaining a joined product by joining a first joining portion and a second joining portion superimposed on the first joining portion, the first joining portion being formed extending linearly on a first workpiece, the second joining portion being formed extending linearly on a second workpiece, the joined product manufacturing apparatus including: a pressing force applying unit configured to apply a pressing force for pressing the second joining portion toward the first joining portion and thereby cause the second joining portion to approach the first joining portion; a laser light irradiation apparatus configured to irradiate, with laser light, regions of the first joining portion and the second joining portion that have been brought near each other by applying the pressing force from the pressing force applying unit; and a movement device configured to move the pressing force applying unit and the laser light irradiation apparatus together along an extension direction of the first joining portion and the second joining portion, wherein the laser light irradiation apparatus irradiates the regions with the laser light from a direction inclined relative to the extension direction of the first joining portion and the second joining portion.

According to the present invention, a pressing force toward the first joining portion is applied to the second joining portion. The first joining portion and second joining portion that are in proximity to each other due to this pressing force are irradiated with laser light, and therefore the first joining portion and second joining portion can be easily joined, even in a case where the first joining portion and the second joining portion are separated away from each other.

Furthermore, laser light is emitted from the direction inclined relative to the extension direction of the first joining portion and the second joining potion. As a result, interference of the laser light with objects or the like is avoided. Thus, the laser light can easily enter between the first joining portion and the second joining portion.

### BRIEF DESCRIPTION OF DRAWINGS

FIG. 1 is a schematic perspective view of a state in which a first joining portion (second flange portion) and a second joining portion (fourth flange portion) of a semi-finished product are irradiated with laser light, while these joining portions are sandwiched by a first roller and a second roller forming a pressing force applying unit;

FIG. 2 is an overall schematic perspective view of a joining apparatus that is a joined product manufacturing apparatus;

FIG. 3 is a schematic perspective view of main components of a laser light irradiation unit forming the joining apparatus of FIG. 2, seen from a front side;

FIG. 4 is a schematic perspective view of main components of the laser light irradiation unit of FIG. 3, seen from a back side;

FIG. 5 is a planar view of main components showing the inclination of the laser light relative to the extension direction of the second flange portion and the fourth flange portion;

FIG. 6 is a front view of main components showing the inclination of the laser light relative to the horizontal direction;

FIG. 7 shows a schematic flow of a joined product manufacturing method;

FIG. 8 is a cross-sectional view of main components at the joining location between the second flange portion and the fourth flange portion; and

FIG. 9 is a schematic perspective view of main components showing a state in which joining is being performed on the second flange portion and the fourth flange portion of the semi-finished product stored in a storage jig provided with a guide board serving as a guide member.

### DESCRIPTION OF THE INVENTION

The following describes, for a method of manufacturing a joined product according to the present invention, details of a preferred embodiment relating to a joined product manufacturing apparatus for implementing this manufacturing method and a semi-finished product of a joined product for realizing this joined product, while referencing the accompanying drawings. In the following description, the “semi-finished product of a joined product” and the “joined product manufacturing apparatus” are referred to respectively as a “semi-finished product” and a “joining apparatus”.

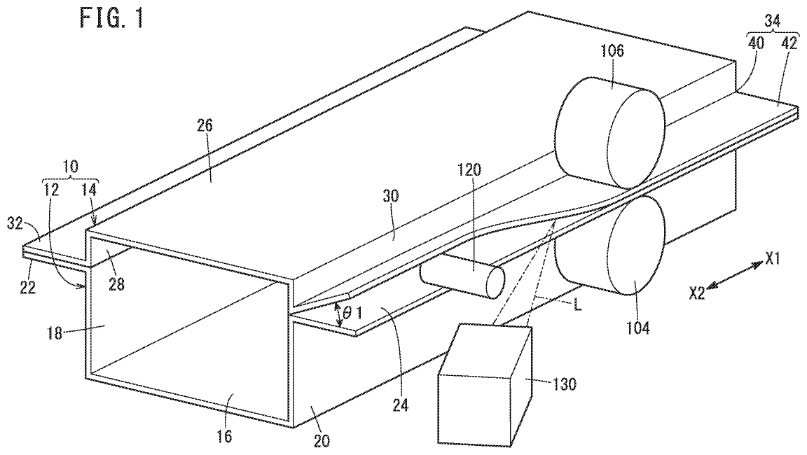

First, the semi-finished product will be described. As shown in FIG. 1, a semi-finished product 10 includes a first workpiece 12 and a second workpiece 14. Among these, the first workpiece 12 has a hollow rectangular-pillar shape with an open top end, formed by a floor wall 16 and a first side wall 18 and second side wall 20 that stand up substantially vertically from the floor wall 16. Furthermore, the first side wall 18 is provided with a first flange portion 22 that is bent substantially 90° to protrude outward from the first workpiece 12. Similarly, the second side wall 20 is provided with a second flange portion 24 that is bent substantially 90° to protrude outward from the first workpiece 12. The first flange portion 22 and the second flange portion 24 (both of which are first joining portions) extend along the longitudinal direction of the first workpiece 12.

The second workpiece 14 has a hollow rectangular-pillar shape with an open bottom end, formed by a ceiling wall 26 and a third side wall 28 and fourth side wall 30 that extend substantially vertically downward from the ceiling wall 26. Furthermore, the third side wall 28 and the fourth side wall 30 are provided respectively with a third flange portion 32 and a fourth flange portion 34 that protrude outward from the second workpiece 14. The third flange portion 32 and the fourth flange portion 34 (both of which are second joining portions) extend along the longitudinal direction of the second workpiece 14.

The longitudinal direction of the second workpiece 14 (extension direction of the third flange portion 32 and fourth flange portion 34) is the same as the longitudinal direction of the first workpiece 12 (extension direction of the first flange portion 22 and second flange portion 24). In the manner described above, the first flange portion 22 to the fourth flange portion 34 are each a joining portion with a linear shape. FIG. 1 schematically shows a state in which the first flange portion 22 and third flange portion 32 have already been joined, and the second flange portion 24 and the fourth flange portion 34 are in the midst of being joined.

In this case, the second workpiece 14 is a formed product manufactured using press forming, and springback occurs in the third flange portion 32 and the fourth flange portion 34. Therefore, when providing a description using the second flange portion 24 and the fourth flange portion 34 as examples, the width direction tip of the fourth flange portion 34 moves away from the width direction tip of the second flange portion 24, which is oriented substantially horizontally, as shown in FIG. 1.

Specifically, the fourth flange portion 34 includes a seating portion 40, which contacts a top surface of the second flange portion 24, and a superimposed portion 42, which is connected to the seating portion 40 and superimposed onto the second flange portion 24 through joining. Then, due to the springback, the superimposed portion 42 before being joined is inclined in a direction away from the second flange portion 24, with the seating portion 40 as a starting point. The inclination angle θ1 of the superimposed portion 42 is approximately less than or equal to 40°, and is typically from 10° to 40°.

The joined product is obtained by joining the third flange portion 32 and fourth flange portion 34 of the second workpiece 14 respectively to the first flange portion 22 and second flange portion 24 of the first workpiece 12 described above. Next, the joining apparatus that performs this joining is described.

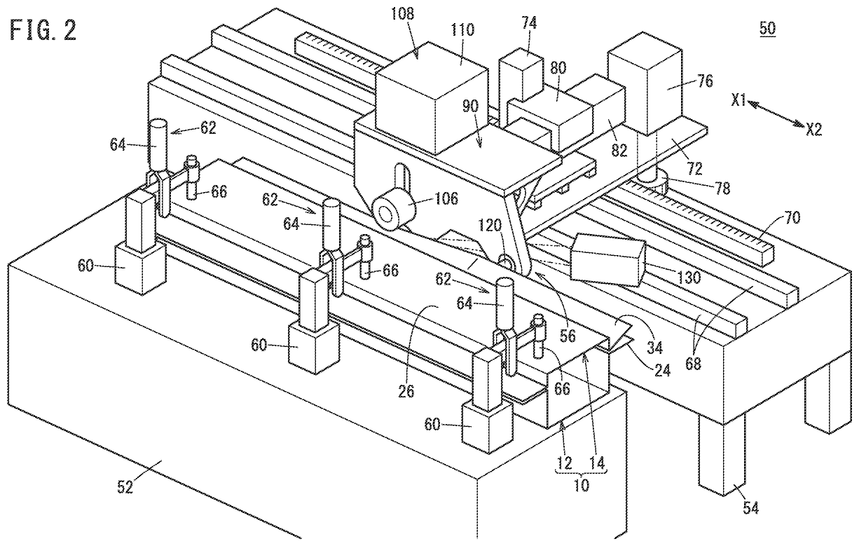

FIG. 2 is an overall schematic perspective view of a joining apparatus 50 according to the present embodiment. The joining apparatus 50 includes a support platform 52 acting as a support jig, and a laser light irradiation unit 56 movably supported on a guide platform 54.

The support platform 52 has a substantially rectangular parallelepiped shape. A plurality (three in the example shown in the drawing) of clampers 62 are provided as positioning tools on the flat top surface of the support platform 52, with the pedestal 60 interposed therebetween. When handles 64 of the clampers 62 have an upright posture extending in the vertical direction, pressing bars 66 of these clampers 62 presses the ceiling wall 26 of the second workpiece 14 toward the support platform 52. By having the clampers 62 press the ceiling wall 26 in this manner, the second workpiece 14 and the first workpiece 12 having the second workpiece 14 placed thereon are sandwiched and held between the pressing bars 66 and the top surface of the support platform 52. As a result, the semi-finished product 10 is positioned and fixed on the support platform 52. On the other hand, when the handles 64 have a recumbent posture extending in the horizontal direction, the pressing bars 66 are separated from the ceiling wall 26. Due to this separation, the semi-finished product 10 is released from the restraint of the clampers 62.

The guide platform 54 for guiding the laser light irradiation unit 56 is provided near the support platform 52. The longitudinal direction of the guide platform 54 is substantially parallel to the longitudinal direction of the second flange portion 24 and fourth flange portion 34.

Two guide rails 68 and one rack 70, which extend along the longitudinal direction of the guide platform 54, are provided on the top surface of the guide platform 54. Each of the two guide rails 68 slidably engages with a slider (not shown in the drawings), and a moving board 72 straddles these two sliders. A pillar-shaped guide member 74 is disposed on the moving board 72 in an upright manner, and a movement motor 76 formed by a servo motor is supported on the moving board 72. The rotational shaft of the movement motor 76 is inserted through an insertion hole that passes through the moving board 72 in a thickness direction thereof, and faces the top surface of the guide platform 54. A pinion 78 is externally fitted on the tip of the rotational shaft, and the pinion 78 meshes with the rack 70 described above. The movement motor 76, the pinion 78, and the rack 70 form a movement means.

Accordingly, due to the rotation of the rotational shaft, the laser light irradiation unit 56 moves in the X2 direction from the X1 direction, together with the moving board 72. In this case, the X1 direction is an upstream side, and the X2 direction is a downstream side.

A first displacement body 80 having a substantially rectangular tube shape engages slidably with the pillar-shaped guide member 74. Furthermore, a second displacement body 82 shaped as a slightly long substantially rectangular pillar is slidably inserted into the hollow inside of the first displacement body 80. Both end portions of the second displacement body 82 in the longitudinal direction are exposed from the first displacement body 80.

The laser light irradiation unit 56 is provided on the tip of the second displacement body 82 facing the support platform 52 side. The following describes the laser light irradiation unit 56.

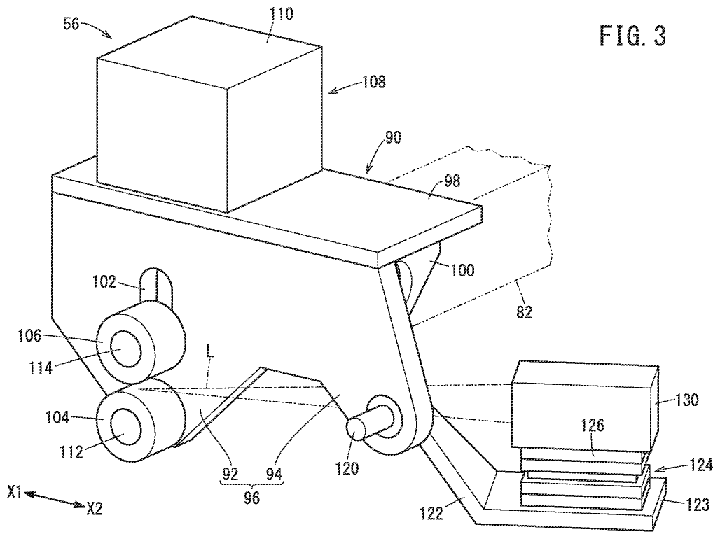

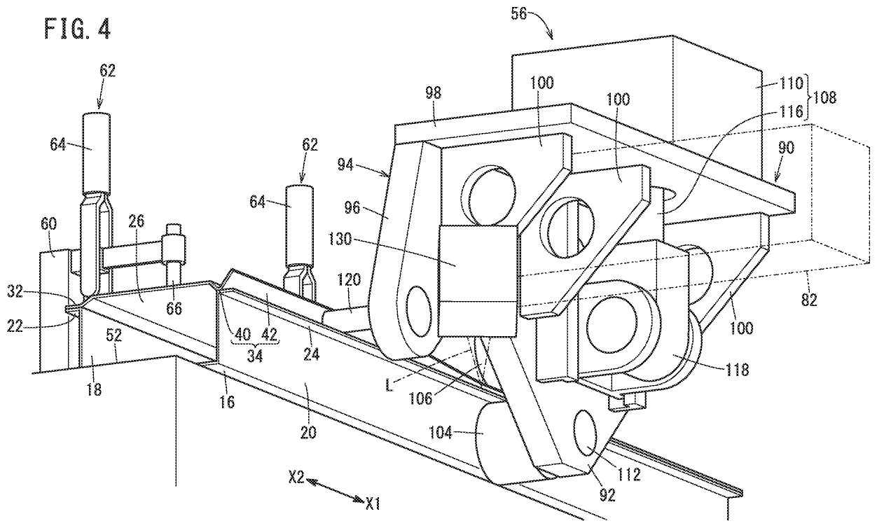

As shown in detail in FIGS. 3 and 4, the laser light irradiation unit 56 includes a holding board 90. The holding board 90 includes a side board portion 96, which has a bifurcated shape having a wide portion 92 and a narrow portion 94, and a ceiling board portion 98 that is connected to the top surface of the side board portion 96. The side board portion 96 is provided on an end portion of the ceiling board portion 98 that is located on the support platform 52 side, and three connection support boards 100 are provided in parallel on the guide platform 54 side end surfaces of the side board portion 96 and the ceiling board portion 98. The tip of the second displacement body 82 is connected to these connection support boards 100. Therefore, in accordance with the second displacement body 82 sliding relative to the first displacement body 80, the laser light irradiation unit 56 is displaced to approach or move away from the support platform 52 or the semi-finished product 10. Furthermore, a long hole 102 extending in the vertical direction penetrates through the wide portion 92.

A pressing force applying unit is provided to the holding board 90. In this case, the pressing force applying unit includes a first roller 104, a second roller 106 arranged above the first roller 104, and an air cylinder 108 that displaces the second roller 106 in a direction toward or away from the first roller 104. A cylinder tube 110 of the air cylinder 108 is positioned and fixed on the top surface of the ceiling board portion 98.

The first roller 104 is a fixed roller whose support shaft 112 is positioned and fixed on the holding board 90. In contrast to this, a support shaft 114 of the second roller 106 is connected to a bottom end of a displacement rod 116 extending from the cylinder tube 110, via a joint 118 positioned between two connection support boards 100. That is, the second roller 106 moves toward the first roller 104 in accordance with advancement (lowering) of the displacement rod 116, and moves away from the first roller 104 in accordance with retraction (rising) of the displacement rod 116. The support shaft 114 of the second roller 106 passes through the long hole 102 to be exposed on the support platform 52 side.

An opening roller 120, which is a separation state maintaining tool, is positioned and fixed on the narrow portion 94. In other words, the opening roller 120 is a fixed roller. As described further below, the opening roller 120 enters between the second flange portion 24 and the superimposed portion 42 that are separated from each other, and maintains the second flange portion 24 and the superimposed portion 42 in the separated state.

As shown in FIG. 3, one end of an arm member 122 is connected to the end surface of the side board portion 96 facing the guide platform 54, at a location that is the boundary between the wide portion 92 and the narrow portion 94. A horizontal surface portion 123 shaped as a flat board is formed on the other end of the arm member 122. A widely known 5-axis stage 124 is provided on this horizontal surface portion 123, and a laser light irradiator 130 (laser light irradiation apparatus) is positioned and fixed on a topmost goniometric stage 126 forming the 5-axis stage 124. By suitably operating the 5-axis stage 124, the position of the laser light irradiator 130 in two horizontal directions and the vertical direction is adjusted, and the inclination angle relative to the vertical direction and facing direction (rotational angle) in the horizontal direction are adjusted. In FIGS. 2 and 4, the arm member 122, the 5-axis stage 124, and the like are omitted from the drawings.

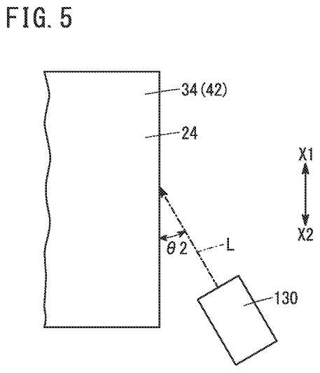

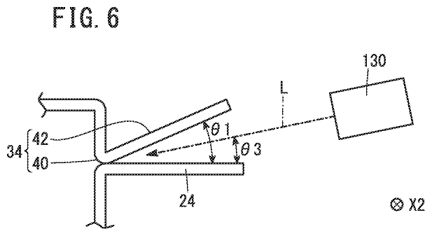

The tip of the laser light irradiator 130 points at a region, in the second flange portion 24 and superimposed portion 42, between the opening roller 120 and the first roller 104 and second roller 106. In other words, the laser light L is emitted toward the second flange portion 24 and the superimposed portion 42, through the space between the opening roller 120 and the first roller 104 and second roller 106. Therefore, the irradiation direction of the laser light L is inclined at prescribed angles θ2 and θ3, as shown in FIGS. 5 and 6, relative to the longitudinal direction (extension direction) of the second flange portion 24 and superimposed portion 42 and to the horizontal direction.

The joining apparatus 50 is basically configured as described above, and the following describes the relationship between the operational effect of the joining apparatus 50 and the method of manufacturing the joined product.

The second workpiece 14 is manufactured by applying press forming to a steel plate material, for example. The entirety of the second workpiece 14 is thin, and the third flange portion 32 and fourth flange portion 34 warp toward the ceiling wall 26 due to the springback. In other words, the seating portions 40 corresponding to the bending points of the third side wall 28 and fourth side wall 30 and the superimposed portions 42 that are inclined from the seating portions 40 toward the ceiling wall 26 are formed on the third flange portion 32 and fourth flange portion 34. In the present embodiment, the second workpiece 14 formed in this manner is superimposed on the first workpiece 12 to form the semi-finished product 10, and then laser welding is applied to the semi-finished product 10 to obtain the joined product.

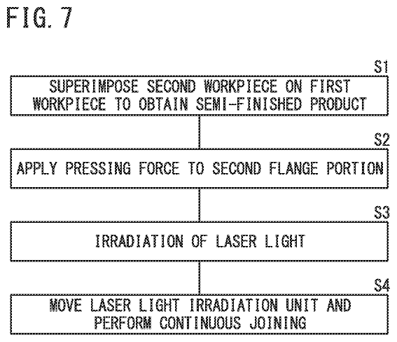

FIG. 7 is a schematic flow of the manufacturing method that includes obtaining the semi-finished product 10 and then obtaining the joined product from this semi-finished product 10. This manufacturing method includes a contact step S1, a pressing force applying step S2, an irradiating step S3, and a joining step S4. Unless otherwise specified, each operation is realized by sequence control performed by a control section (not shown in the drawings). Furthermore, in the following, an example is described of a case in which the second flange portion 24 and the fourth flange portion 34 are joined after the first flange portion 22 and the third flange portion 32 have been joined.

In the contact step S1, the second workpiece 14 is superimposed on the first workpiece 12 to obtain the semi-finished product 10, as described above. At this time, as shown in FIG. 1, the seating portions 40 of the third flange portion 32 and fourth flange portion 34 of the second workpiece 14 contact the first flange portion 22 and second flange portion 24 of the first workpiece 12. On the other hand, the superimposed portion 42 is away from the second flange portion 24.

The semi-finished product 10 obtained by superimposing the second workpiece 14 on the first workpiece 12 is placed on the top surface of the support platform 52. The first workpiece 12 may be placed on the top surface of the support platform 52 first, and then the second workpiece 14 may be superimposed on the first workpiece 12. At this time, the clampers 62 are at a release position where the handles 64 are in the upright posture and the pressing bar 66 is raised, and the semi-finished product 10 is installed such that the ceiling wall 26 is positioned below the pressing bar 66.

Next, the semi-finished product 10 is positioned and fixed to the support platform 52. That is, an operator grips and pivots the handles 64 of the clampers 62 to set the handles 64 to the recumbent posture. In accordance with this pivoting (posture change), the pressing bar 66 is lowered to press against the ceiling wall 26. The semi-finished product 10 is restrained by the clampers 62 due to this pressing, and is positioned and fixed on the support platform 52.

Next, positional alignment of the laser light irradiation unit 56 is performed. Specifically, the movement motor 76 is energized to rotate the pinion 78 and the first displacement body 80 and second displacement body 82 are suitably displaced, such that the first roller 104 contacts the second flange portion 24 from below and the second roller 106 reaches a standby position above the fourth flange portion 34. At this time, the opening roller 120 is interposed between the second flange portion 24 and the superimposed portion 42.

The position of the laser light irradiator 130 is adjusted as needed. That is, the operator rotates an adjustment knob forming the 5-axis stage 124 to adjust the position and angle such that the tip of the laser light irradiator 130 lies slightly downstream in the forward movement direction (X2 direction) of the first roller 104 and the second roller 106. A camera may be attached to the laser light irradiator 130, the positional misalignment amount may be judged based on an image from this camera, and the position and angle of each stage may be adjusted automatically.

Furthermore, in order to implement the pressing force applying step S2, the air cylinder 108 is operated. Due to this, the displacement rod 116 is lowered and the second roller 106 whose support shaft 114 is provided to the displacement rod 116 via the joint 118 lowers to approach the first roller 104. The second roller 106 contacts the superimposed portion 42 during this lowering, and furthermore, the second roller presses the superimposed portion 42 toward the second flange portion 24. In other words, due to the second roller 106 that is lowered by the effect of the air cylinder 108, a pressing force is applied to a portion of the fourth flange portion 34.

The region of the fourth flange portion 34 where the pressing force is applied is deformed such that the superimposed portion 42 approaches the second flange portion 24, with the seating portion 40 as a starting point. In other words, the region of the superimposed portion 42 pressed by the second roller 106 contacts (sits on) the second flange portion 24, and a region slightly downstream from the second roller 106 is slightly pushed to approach the second flange portion 24. However, the latter region is kept in a separated state because the opening roller 120 interposes between the second flange portion 24 and the superimposed portion 42.

At substantially the same time that this pressing force is applied, the laser light L is emitted from the laser light irradiator 130 and the laser light irradiation unit 56 is moved. In other words, the irradiation step S3 and the joining step S4 are performed. When describing the irradiation step S3, the laser light L enters a region, between the second flange portion 24 and the superimposed portion 42, slightly downstream from the first roller 104 and second roller 106 in the forward movement direction of the first roller 104 and second roller 106. As described above, this region is kept in a separated state by the opening roller 120. In other words, the superimposed portion 42 is not yet in contact with the second flange portion 24. Accordingly, the laser light L is sufficiently incident to the top surface of the second flange portion 24 and the bottom surface of the superimposed portion 42.

In a case where the second workpiece 14 is made of a material exhibiting high tension, the inclination angle of the fourth flange portion 34 relative to the horizontal direction is not particularly large. Accordingly, it is not easy to irradiate a region between the second flange portion 24 and the fourth flange portion 34 with the laser light L. However, in the present embodiment, the opening roller 120 is interposed between the second flange portion 24 and the superimposed portion 42. Due to this, the inclination angle θ1 of the superimposed portion 42 relative to the second flange portion 24 (or the horizontal direction) can be set to approximately 10° to 40°. Accordingly, the laser light L can easily get in between the second flange portion 24 and the superimposed portion 42.

In this way, regions of the second flange portion 24 and superimposed portion 42 slightly on the downstream side in the forward movement direction of the first roller 104 and second roller 106 are pressed by the opening roller 120 such that these regions are kept separated from each other, and therefore it is possible to easily cause the laser light L to enter in between the second flange portion 24 and the superimposed portion 42. Obviously, the regions on the top surface of the second flange portion 24 and bottom surface of the superimposed portion 42 irradiated with the laser light L are melted by the incident heat of the laser light L.

As shown in FIGS. 5 and 6, the irradiation direction of the laser light L produced by the laser light irradiator 130 is inclined at prescribed angles θ2 and θ3 relative respectively to the longitudinal direction of the second flange portion 24 and superimposed portion 42 and the horizontal direction. θ2 is approximately less than or equal to 30°, and preferably in a range of 20° to 30°. Furthermore, θ3 is approximately less than or equal to 10°, and preferably in a range of 5° to 10°.

As understood from the above, in the present embodiment, there is no need to emit laser light L from below the second flange portion 24 or above the superimposed portion 42 for the purpose of causing the laser light L to reach the contact interface between the second flange portion 24 and the superimposed portion 42. Accordingly, it is possible to reduce the energy consumption by a corresponding amount. Due to this, even in a case where the first workpiece 12 and second workpiece 14 are made of galvanized steel plates, excessive evaporation of the zinc plating is avoided, and therefore the formation of blow holes is also avoided. Accordingly, the obtained joined product is aesthetically pleasing.

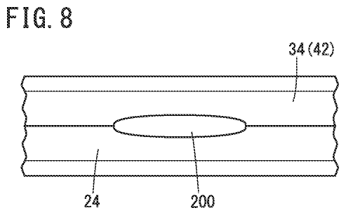

Furthermore, since the irradiation direction of the laser light L is inclined as described above, a joining portion 200 is formed across a wide range of the second flange portion 24 and the superimposed portion 42, as shown in FIG. 8. In other words, the second flange portion 24 and the superimposed portion 42 can be joined across a wide range.

On the other hand, by continuing (or restarting) the energization of the movement motor 76, the moving board 72 moves along the longitudinal direction of the second flange portion 24 and fourth flange portion 34 due to the effects of the pinion 78 and the rack 70 meshing with the pinion 78. At this time, the moving board 72 is guided by the guide rail 68.

The first displacement body 80 and second displacement body 82 are provided on the moving board 72 and the laser light irradiation unit 56 is provided on the tip of the second displacement body 82. Accordingly, the first roller 104, the second roller 106, the opening roller 120, and the laser light irradiator 130 are displaced in the longitudinal direction of the second flange portion 24 and fourth flange portion 34, integrally with the moving board 72, the first displacement body 80, and the second displacement body 82.

In other words, the region melted in the manner described above is quickly sandwiched by the first roller 104 and second roller 106 that have moved to this region. Due to this sandwiching, the melted region on the bottom surface of the superimposed portion 42 contacts the melted region on the top surface of the second flange portion 24. Due to the first roller 104 and second roller 106 passing these regions therethrough in a sandwiched state, the springback of the fourth flange portion 34 is corrected and these regions are firmly fusion-bonded together. After this, the fusion-bonded regions are cooled, resulting in these regions being joined to each other.

In accordance with the laser light irradiation unit 56 moving, the phenomenon described above occurs continuously along the longitudinal direction of the second flange portion 24 and fourth flange portion 34. Accordingly, the superimposed portion 42 is joined to the second flange portion 24 along the longitudinal direction. In the manner described above, a joined product is obtained in which the first flange portion 22 and third flange portion 32 are joined together and the second flange portion 24 and fourth flange portion 34 are joined together. Although not specifically described, the first flange portion 22 and third flange portion 32 are also joined together in the same manner as described above.

In this way, by emitting the laser light L from a direction inclined relative to the longitudinal direction of the first flange portion 22 to fourth flange portion 34, the laser light L easily enters between the first flange portion 22 and third flange portion 32 or between the second flange portion 24 and fourth flange portion 34, without interference with the holding board 90 and the like. Therefore, even in a situation where springback or the like occurs and causes separation, joining of the first flange portion 22 and third flange portion 32 and joining of the second flange portion 24 and fourth flange portion 34 can easily be performed.

Furthermore, the opening roller 120 rotates when displaced integrally with the holding board 90. Accordingly, damage to the second flange portion 24 and superimposed portion 42 is avoided.

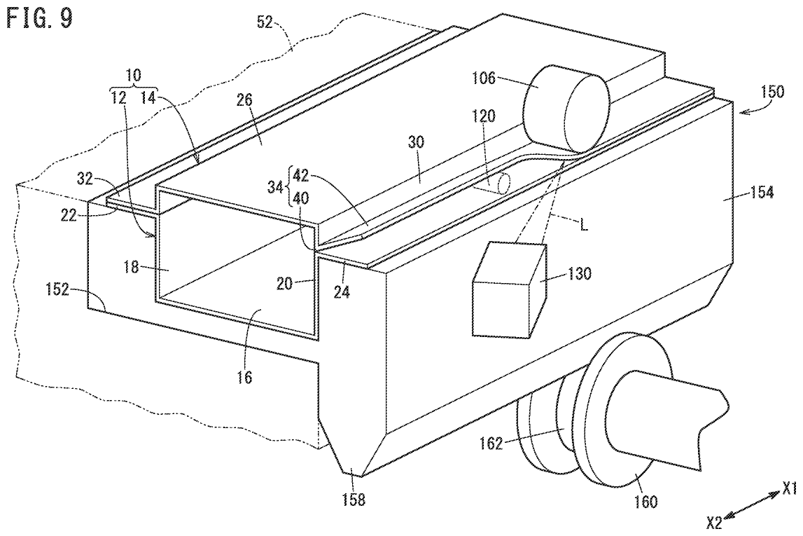

Instead of placing the first workpiece 12 on the support platform 52 (see FIG. 2), the first workpiece 12 may be stored inside a storage jig 150 serving as a support jig, as shown in FIG. 9. The following describes such an embodiment. Constituent elements that are the same as those shown in FIGS. 1 to 4 are given the same reference numerals, and detailed descriptions thereof are omitted. Furthermore, in FIG. 9, to facilitate understanding, components other than the main components such as the laser light irradiator 130 are not shown.

In this case, a stepped portion 152 is formed in the support platform 52. The storage jig 150 is positioned and fixed to the stepped portion 152. One end of the storage jig 150 in the width direction protrudes from the support platform 52 toward the guide platform 54 (see FIG. 2). On this one end in the width direction, a guide board 154 serving as a guide member is formed integrally with the storage jig 150. Furthermore, although omitted from the drawings, similarly to FIGS. 2 and 4, clampers 62 are provided near the other end of the storage jig 150 in the width direction, on the top surface of the support platform 52.

The guide board 154 has, on a bottom end thereof, a convex portion 158 protruding from the bottom end. On the other hand, a wheel 160, instead of the first roller 104, is positioned and fixed in a rotatable manner on the wide portion 92 of the holding board 90. This wheel 160 is wider than the guide board 154, and a rim diameter thereof is set to be small in the middle thereof in the height direction. In other words, a recessed portion 162 is formed in the wheel 160, and the recessed portion 162 engages with the convex portion 158 of the guide board 154.

In the present embodiment, the second flange portion 24 and fourth flange portion 34 are placed on the one end portion of the storage jig 150 in the width direction, and the first flange portion 22 and third flange portion 32 are placed on the other end portion thereof in the width direction. In other words, the second flange portion 24 and fourth flange portion 34 are sandwiched by the one end of the storage jig 150 in the width direction and the second roller 106. In this state, when the second roller 106 moves on the width direction one end portion while the laser light L is being emitted, the second roller 106 receives a reactive force from the storage jig 150. Therefore, a sufficient pressing force can be applied to the second flange portion 24 and fourth flange portion 34.

Furthermore, since the second roller 106 moves in a state where the recessed portion 162 of the wheel 160 and the convex portion 158 of the guide board 154 are engaged with each other, the second roller 106 is prevented from falling off the second flange portion 24 and fourth flange portion 34. In other words, by guiding the laser light irradiation unit 56 with the guide board 154, it becomes easier to correct the fourth flange portion 34 with the second roller 106.

The present invention is not limited to the above-described embodiment, and various modifications could be adopted therein without departing from the essence and gist of the present invention.

For example, a multi-jointed robot may be adopted instead of the guide platform 54, the movement motor 76, the rack 70, the pinion 78, and the like. In such a case, the laser light irradiation unit 56 should be provided on the tip arm of the multi-jointed robot. In other words, the multi-jointed robot functions as a movement mechanism that moves the laser light irradiation unit 56.

What is claim is:

1. A joined product manufacturing apparatus for obtaining a joined product by joining a first joining portion and a second joining portion superimposed on the first joining portion, the first joining portion being formed extending linearly on a first workpiece, the second joining portion being formed extending linearly on a second workpiece, the joined product manufacturing apparatus comprising:
a pressing force applying unit configured to apply a pressing force for pressing the second joining portion toward the first joining portion and thereby cause the second joining portion to approach the first joining portion;
a laser light irradiation apparatus configured to irradiate, with laser light, regions of the first joining portion and the second joining portion that have been brought near each other by applying the pressing force from the pressing force applying unit; and
a movement device configured to move the pressing force applying unit and the laser light irradiation apparatus together along an extension direction of the first joining portion and the second joining portion,
wherein the laser light irradiation apparatus irradiates the regions with the laser light from a direction inclined relative to the extension direction of the first joining portion and the second joining portion.

2. The joined product manufacturing apparatus according to claim 1, further comprising a holding board provided with the pressing force applying unit and the laser light irradiation apparatus,
wherein the pressing force applying unit and the laser light irradiation apparatus move together with the holding board.

3. The joined product manufacturing apparatus according to claim 1, further comprising a positioning tool configured to press the second workpiece toward the first workpiece and thereby position and fix the first workpiece and the second workpiece.

4. The joined product manufacturing apparatus according to claim 1, further comprising a support jig configured to support the first workpiece.

5. The joined product manufacturing apparatus according to claim 4, wherein the support jig is provided with a guide member configured to guide the pressing force applying unit which moves along the first joining portion and the second joining portion.

6. The joined product manufacturing apparatus according to claim 1, further comprising a separation state maintaining tool configured to enter between the first joining portion and the second joining portion on a downstream side in a forward movement direction of the pressing force applying unit and maintain the first joining portion and the second joining portion in a mutually-separated state.

7. The joined product manufacturing apparatus according to claim 1, wherein the pressing force applying unit includes a pair of rollers configured to sandwich the first joining portion and the second joining portion therebetween.
